(19) United States
(12) Patent Application Publication
(10) Pub. No.: US 2006/0079429 A1
(43) Pub. Date: Apr. 13, 2006

(54) Cleaning

(75) Inventor: Adrian Blagg, East Yorkshire (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, SLOUGH, BERKSHIRE (GB)

(21) Appl. No.: 10/523,594

(22) PCT Filed: Aug. 8, 2003
(86) PCT No.: PCT/GB03/03472

§ 371 Date: Mar. 4, 2005

(30) Foreign Application Priority Data
Aug. 9, 2002 (GB) 0218538.7

(51) Int. Cl. C11D 3/00

(52) U.S. Cl. 510/379

(57) ABSTRACT

A two-liquid hard surface cleaner contains a thin alkaline liquid and a thin acidic liquid. Stabilised in the alkaline liquid is a compound which generates chlorine dioxide only under acidic conditions. An example is sodium chlorite. The liquids are mixed to form a thick cleaning composition. Ethoxylated alkyl sulphate surfactants have been found to be highly effective in achieving this effect of thickening on mixing. The thickened cleaning composition is acidic and causes the evolution of chlorine dioxide, which has a sterilising and bleaching effect. The resulting acidic liquid is also able to degrade limescale.

The present invention relates to a cleaning composition, a cleaning pack and a method of cleaning. The composition, pack and method are of particular interest in relation to the cleaning of hard surfaces, especially sanitaryware, notably lavatories.

Lavatory cleaners are purchased by customers with a view to killing germs and also removing limescale and other stains. Typically, conventional lavatory cleaners are based on sodium hypochlorite or hydrochloric acid. They may be supplied as thin liquid compositions, or as thickened compositions. Thin liquid compositions have the disadvantage of short residence time on an upright or inclined sanitaryware surface, above a water line. Thickened compositions may have a longer residence time on an upright or inclined sanitaryware surface, but may be more difficult to dispense from a typical squeeze pack.

Compositions have been disclosed in which there is a first liquid containing sodium chlorite, stabilised under alkaline conditions, and a second, acidic, liquid, the acid being present in an amount in excess of that needed to neutralise the first liquid. The two liquids are mixed at the point of use to form a cleaning composition. The sodium chlorite is then in an acidic environment, and releases chlorine dioxide. An example of such a composition is described in WO 98/57544. However, in such examples the problem of using thin, non-clinging liquids or viscous, difficult to impel liquids still exists.

In accordance with a first aspect of the invention there is provided a hard surface cleaner comprising a first precursor composition, being a thin alkaline liquid which contains a compound which generates chlorine dioxide under acidic conditions but not under alkaline conditions, and a second precursor composition, being a thin acidic liquid, wherein on mixing the first and second precursor compositions the resulting admixed cleaning composition is acidic, causing the compound to generate chlorine dioxide, and is more viscous than the first precursor composition and more viscous than the second precursor composition.

Although chlorine dioxide is generated on admixture, preferably the cleaning composition is formulated to be non-foaming.

Preferably the first precursor composition is an aqueous composition.

Preferably the second precursor composition is an aqueous composition.

Preferably the cleaning composition does not generate chlorine gas.

Preferably the cleaning composition comprises a colour change agent. Initially, on mixing of the two precursor compounds, the resulting admixed cleaning composition is of a first appearance but changes to a second appearance, of different colour, preferably over a short period of time, preferably less than 5 minutes, and more preferably less than 2 minutes. The colour change may be promoted by any chemical change at work. For example it may be caused by the breakdown of the compound which generates chlorine dioxide. It may be promoted by the evolution of chlorine dioxide. It may be promoted by the pH change.

A colour change agent may be contained within the first precursor composition, or the second precursor composition, or both.

Preferably, a colour change agent is contained within the second precursor composition and employs a colour change agent which is oxidised by the chlorine dioxide evolved. Preferably it comprises a dye which is oxidised and a dye which is resistant to oxidation, so that the change is not from coloured to colourless, but from a first colour to a second colour. An example of a suitable oxidisable dye is acid blue. An example of a dye resistant to oxidation is methylene blue.

By “thin” we mean that the viscosity of such a liquid is like that of water, or not very much higher than that. Suitably a thin liquid herein has a viscosity of less than 100 cps, preferably less than 50 cps, and more preferably less than 20 cps. Especially favoured thin liquids have a viscosity less than 10 cps.

Suitably a thin liquid herein has a viscosity of at least 0.5 cps, preferably at least 1 cps, most preferably at least 2 cps.

Preferably the viscosity of the admixed cleaning composition is at least 150 cps, more preferably at least 400 cps, and most preferably at least 500 cps. It is especially preferred that the admixed cleaning composition is of a viscosity greater than 700 cps.

Preferably the viscosity of the admixed cleaning composition does not exceed 4,000 cps. Typically, it does not exceed 2,000 cps, or, preferably, 1000 cps.

For reference purposes, when we give values herein for viscosity they are measured at 20° C. using a Brookfield viscometer, Spindle LV 2, 60 rpm.

Preferably, then, on mixing of the two precursor compositions the resulting admixed cleaning composition thickens, so that it has a longer residence time on an upright or inclined hard surface. Preferably its viscosity and/or adherence are such that the admixed cleaning composition, or at least a proportion of it, clings to the surface until flushed therefrom.

Preferably the first precursor composition and/or the second precursor composition contains a surfactant which thickens the admixed composition, when admixture takes place. In order not to thicken the precursor composition in which it initially resides, the surfactant should be responsive to the other precursor composition. Most conveniently the surfactant is responsive to pH. Since the second precursor composition and the admixed cleaning composition are both acidic, the surfactant is preferably comprised within the first precursor composition and provides the thickening effect when it is exposed to the acid in the second precursor composition.

Thus, preferably the surfactant selected is one which provides an increase in viscosity when it undergoes a change from an alkaline to an acidic environment.

Preferred surfactants for use in the present invention are anionic surfactants which provide any of the effects stated above. Especially preferred are alkyl sulphonate, or more preferably, alkyl sulphate surfactants, especially C₈₋₂₀ (preferably linear) alkyl sulphate surfactants.

Preferred alkyl sulphate surfactants are alkali metal salts, especially sodium salts.

Preferred anionic surfactants are alkoxylated, preferably by 1-8, more preferably 1-4, especially 1 or 2, alkoxy groups per anionic surfactant molecule, on average. Preferred alkoxy groups are ethoxy groups, although other alkoxy groups, notably propoxy groups, are not excluded.

Preferably the first precursor liquid contains, as the compound which generates chlorine dioxide under acidic conditions, an alkali metal chlorate or, preferably, an alkali metal chlorite. Sodium salts are preferred.

Optionally the first and/or second precursor liquid contains, in addition to materials already mentioned, a water-soluble metal salt. The cation is preferably an alkali metal ion, most preferably a sodium ion. The anion is preferably derived from a mineral acid. Most preferably it is a halide ion, especially a chloride ion.

Preferably the pH of the first precursor composition is at least 8, preferably at least 10, and more preferably at least 12. The compound which generates chlorine dioxide under acidic conditions, contained with the first precursor composition, may itself be a base but the first composition preferably contains an additional base, suitably an alkali metal base, for example a hydroxide. Sodium hydroxide is favoured for this purpose.

When an additional base is provided in the first liquid precursor, it is suitably provided in an amount of at least 0.05% w/w, preferably at least 0.1% w/w, based on the total cleaning composition.

When an additional base is provided in the first liquid precursor, it is suitably provided in an amount up to 1% w/w, preferably up to 0.5% w/w, based on the total cleaning composition.

Preferably the second precursor liquid has a pH of up to 5, more preferably up to 3.5, and most preferably up to 2.5. Suitably the acidifying compound is a mineral acid, preferably hydrochloric acid.

The pH of the admixed cleaning composition will exceed the pH of the second precursor composition, due to the alkalinity of the first precursor composition. The pH of the admixed cleaning composition is preferably no more than 0.5 pH units higher than that of the second precursor or liquid, and so is preferably of pH up to 5.5, more preferably up to 4, and most preferably up to 3.

Unless otherwise stated pH values are stated herein with reference to a composition diluted at a ratio of 1 part of composition to 100 parts of deionised water, by volume.

The composition may contain other ingredients including additional surfactants, fragrances, stabilisers and buffers.

Additional surfactants include nonionic and amphoteric (or zwitterionic) surfactants. When present the amount of such additional surfactant, or of such additional surfactants in total, is preferably up to 10% w/w, more preferably up 5% w/w, of the total cleaning composition.

One class of nonionic surfactants which may be used in the present invention is alkoxylated alcohols, particularly alkoxylated fatty alcohols. These include ethoxylated and propoxylated fatty alcohols, as well as ethoxylated and propoxylated alkyl phenols, both having alkyl groups of from 7 to 16, more preferably 8 to 13 carbon chains in length. Examples include linear alcohol ethoxylates and secondary alcohol ethoxylates.

Another class of non-ionic surfactants that may be used is sorbitan esters of fatty acids, typically of fatty acids having from 10 to 24 carbon atoms, for example sorbitan mono oleate.

Amphoteric surfactants which may be used in the present invention including amphoteric betaine surfactant compounds having the following general formula: 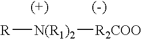
wherein R is a hydrophobic group which is an alkyl group containing from 10 to 22 carbon atoms, preferably from 12 to 18 carbon atoms, an alkylaryl or arylalkyl group containing a similar number of carbon atoms with a benzene ring being treated as equivalent to about 2 carbon atoms, and similar structures interrupted by amido or either linkages; each R₁ is an alkyl group containing from 1 to 3 carbon atoms; and R₂ is an alkylene group containing from 1 to 6 carbon atoms.

A preferred amphoteric surfactant includes an alkyl amino betaine or an alkyl amido betaine.

Suitable amphoteric surfactants also include cocoamides, preferably polyoxyethylene-3-cocoamide.

Suitable amphoteric surfactants also include imidazoline surfactants, for example sodium capryloamphopropionate.

Suitable amphoteric surfactants include lactamide surfactants, for example Lactamide MEA.

Preferably the compound which generates chlorine dioxide under acidic conditions is present in an amount up to 2% w/w of the total cleaning composition, preferably up to 1% w/w of the total cleaning composition. Preferably it is present in an amount of at least 0.02% w/w of the total cleaning composition, preferably at least 0.1% w/w of the total cleaning composition.

Preferably a surfactant responsible for the thickening effect, when present, is present in an amount of at least 0.5% w/w of the total cleaning composition, preferably at least 1% w/w of the total cleaning composition, and most preferably at least 1.5% w/w of the total cleaning composition. Preferably such a surfactant is present in an amount up to 6% w/w of the total cleaning composition, preferably up to 4% w/w, of the total cleaning composition.

Preferably the second precursor liquid contains an acid in an amount up to 15% w/w of the total cleaning composition, preferably up to 10% w/w of the total cleaning composition, and most preferably up to 7% w/w of the total cleaning composition. Preferably such an acid is present in an amount at least 2% w/w of the total cleaning composition, more preferably at least 4% w/w of the total cleaning composition; but in all cases in an amount in excess of that required to neutralise an equal volume of the first precursor composition.

Preferably the normality of an acid present in the second liquid composition is at least 1M, more preferably at least 1.5M, preferably at least 2M. Preferably the normality of the acid in the admixed cleaning composition is at least 0.5M, more preferably at least 0.8M.

Preferably water from the first liquid precursor provides at least 20% w/w of the total cleaning composition, more preferably at least 24% w/w, most preferably at least 28% w/w.

Preferably water from the first liquid precursor provides up to 46% w/w of, more preferably up to 42% w/w, most preferably up to 38% w/w of the total cleaning composition.

Preferably water from the second liquid precursor provides at least 20% w/w of the total cleaning composition, more preferably at least 24% w/w, most preferably at least 28% w/w.

Preferably water from the second liquid precursor provides up to 45% w/w of, more preferably up to 40% w/w, most preferably up to 35%.

Preferably water comprises at least 40% w/w of the admixed cleaning composition, more preferably at least 48%, most preferably at least 56% w/w. Especially preferred are admixed compositions at least 60% water.

Preferably water comprises up to 90% w/w of the admixed cleaning composition, more preferably up to 82% w/w, most preferably up to 74% w/w. Especially preferred are admixed compositions comprising up to 70% water.

Preferably there is provided a hard surface cleaner as defined herein, which comprises (% w/w values stated with reference to the total cleaning composition):
0.02-2% w/w, preferably 0.1-1% w/w, of a compound which under acid conditions generates chlorine dioxide, provided substantially wholly via the first precursor liquid;
0.5-5% w/w, preferably 1.5-4% w/w, of an alkali metal, alkoxylated C₈₋₂₀ alkyl sulphate surfactant which thickens on being acidified, provided partially or substantially wholly via the first precursor liquid;
20-46% w/w, preferably 28-40% w/w, water, provided via the first precursor liquid;
an alkali metal base, provided substantially wholly via the first precursor liquid, in an amount such as to make the pH thereof at least 12;
20-46% w/w, preferably 28-40% w/w, water, provided via the second precursor liquid;
an acid, provided substantially wholly via the second precursor liquid in an amount such as to make the pH thereof not more than 5 and the pH of the admixed cleaning composition not more than 0.5 higher than the pH of the second precursor liquid;
   wherein the viscosity (as measured herein) of the first precursor liquid is in the range 0.1-100 cps, preferably 1-10 cps, the viscosity of the second precursor liquid is in the range 0.1-100 cps, preferably 1-10 cps, and the viscosity of the admixed composition is in the range 150-1400 cps, preferably 500-1000 cps.

In accordance a second aspect of the invention there is provided a hard surface cleaning pack comprising a first chamber containing the first precursor composition, and a second chamber containing the second precursor composition, wherein the chambers are adapted for simultaneous, separate dispensing of the first and second precursor compositions with downstream mixing thereof, the first and second precursor compounds being in accordance with the first aspect of the invention.

The mixing of the first and second precursor compositions can be within a mixing zone adjacent to the outlets of the first and second chambers. However with this kind of arrangement steps may need to be taken to avoid contamination of the contents of the chambers. Therefore in a preferred embodiment the pack is designed to issue separate first and second precursor compositions which mix substantially only when contacting the hard surface.

Containers/dispensers suitable for use in this aspect of the invention are well known. Examples include twin-pack trigger sprays having a mechanical pumping action and side-by-side twin squeeze bottle chambers having simple narrowed nozzle outlets.

In accordance with a third aspect of the invention there is provided a method of cleaning a hard surface, the method comprising use of a cleaning composition which is an in situ mixture of the first precursor composition and the second precursor composition, as defined above in relation to the first aspect of the invention.

Preferably the hard surface is an inclined or upright surface.

Preferably the hard surface is a sanitaryware surface.

Preferably the hard surface is a hard surface of a lavatory, including of a lavatory bowl or of a urinal.

Preferably the method employs 30-70 parts by weight of the first precursor composition, more preferably 40-60 and most preferably 45-55, with the second precursor composition providing the balance. Most advantageously the first and second precursor compositions are dispensed in substantially equal weights. Preferably the pack of the second embodiment is adapted to issue the first and second precursor liquids in accordance with the preceding definitions. Preferably the composition of the first aspect contains the first and second precursor liquids in such proportions.

It will be appreciated that the present invention offers many benefits to the consumer. Thin liquids are employed, and so are easier to dispense than a pre-thickened cleaning composition. The thin liquids become thick on admixture and so attain prolonged residence time, on an upright or inclined surface. On admixture chlorine dioxide is generated. Chlorine dioxide is an effective bleaching and sanitising agent, of sufficiently low odour that it can be masked by a fragrance. The admixed composition is acidic and is able to combat limescale. The colour change agent, when present, gives the consumer a visual indication of these actions. Since in preferred embodiments the colour change agent is responsive directly to the presence of chlorine dioxide, whose evolution is triggered by acid conditions, the colour change can be no mere marketing artefact, but a direct indication of the chemistry which is at work.

The invention will now be further described, by way of illustration, with reference to the following examples. In these examples the following materials are used.

EMPICOL ESB—Sodium C(10-19)-(ethoxy)₂-sulphate, from Huntsman

EMPICOL ESA—Sodium C(10-19)-ethoxy-sulphate, from Huntsman

Acid Blue 182—oxidisable blue dye, from Clariant

Methylene blue—oxidation-resistant blue dye, from Orion Dyes, New Jersey

EMPICOL ESA and EMPICOL ESB are trade marks.

### EXAMPLE 1

### Formulation

This example is of a dual liquid system to be jetted under the toilet rim via a two compartment bottle. Equal volumes of each liquid are mixed on delivery, at the hard surface.

Liquid A is a clear thin liquid containing an unactivated oxidising agent, an alkaline stabilising agent, anionic surfactant, and fragrance, in water. pH at 20° C. is 12.55

Liquid B is a thin blue liquid containing mineral acid and blue dyes in hard water. pH at 20° C. is 1.83.

The liquids are prepared by simple blending.

Full composition information is given below.

LIQUID A

| | | % w/w | % w/w |
|---|---|---|---|
| | Function | Liquid A | Total |
| Ingredient | | | |
| Deionised water | Dilutant | 59.50 | 29.75 |
| Sodium Hydroxide | Stabilising Agent | 10.00 | 5.00 |
| solution 4% w/w, | | | |
| in water | | | |
| Sodium Chlorite | Oxidising Agent | 0.50 | 0.25 |
| 80% w/w, in water | | | |
| Sodium Alkyl | Anionic | 20.00 | 10.00 |
| ethoxy sulphate 2EO | Surfactant/Thickener | | |
| (25.5% soln, in water) | | | |
| Fragrance pre-mix | Fragrance | 10.00 | |
| | | 100.00 | |
| Fragrance pre-mix | | | |
| Commercial fragrance | Fragrance | 2.00 | 0.100 |
| Sodium Alkyl | Anionic Surfactant | 50.00 | 2.500 |
| ethoxy sulphate 2EO | | | |
| 25.5% soln in water) | | | |
| Deionised Water | Dilutant | 48.00 | 2.400 |
| | | 100.00 | 50.000 |

LIQUID B

| | | % w/w | % w/w |
|---|---|---|---|
| | Function | Liquid B | Total |
| Ingredient | | | |
| Hard water | Dilutant | 65.00 | 32.50 |
| Hydrochloric Acid | Acid | 25.00 | 12.50 |
| 37% w/w, in water | | | |
| Dye pre-mix | Dye | 10.00 | |
| | | 100.00 | |
| Dye pre-mix | | | |
| Acid Blue 182 | Readily Oxidised Dye | 0.4000 | 0.020 |
| Methylene Blue | Oxidation Resistant | 0.0250 | 0.001 |
| | Dye | | |
| Hard Water | Dilutant | 99.5750 | 4.979 |
| | | 100.0000 | 50.000 |

The two thin liquids mix to form a dark blue thick liquid, whose pH at 20° C. is 1.96. The acid activates the oxidising agent liberating chlorine dioxide. The acid removes limescale. The surfactant causes the substantial thickening, and aids surface activity.

A colour change from blue to indigo then to green occurs over approximately 1 minute. On standing overnight the colour returns to pale blue.

pH values stated in this specification are of a 1/100^{th} dilution of a sample in deionised water.

### EXAMPLE 1

### Viscosity

The viscosity of Liquid A and Liquid B and of the admixed cleaning composition were tested at 20° C. using a Brookfield viscometer, Spindle LV 2, at 60 rpm.

The viscosity of Liquid A was 5 cps.

The viscosity of Liquid B was 4 cps.

The viscosity of the admixed cleaning composition was 774 cps.

The practical effect of this viscosity increase is that whereas either Liquid A or Liquid B alone quickly run off an inclined surface of a lavatory bowl, when they are mixed the resulting thicker liquid “curtains” evenly and slowly down the surface. A proportion runs into the water in the lavatory bowl, where some of it “pools” at the bottom of the water, in the region where limescale may typically be most prevalent. The remainder clings to the surface, above the water line. After one flush of the lavatory there is significant foaming. Residual foam is still apparent after five flushes.

### EXAMPLE 1

### Limescale Removal

A marble cube (approximately 25 g in weight) was weighed then added to water (2 litres) in a lavatory bowl. 25 g of Liquid A and 25 g of Liquid B were mixed, as they were applied to the region under the rim of a lavatory bowl. The cube was left in contact with the liquid for 6 hours. At the end of this time period the cube was removed with plastic forceps. It was rinsed with tap water, and then deionised water, before drying off any surface water with a paper towel. The marble was further dried in a microwave, allowed to cool, and reweighed.

In a test of limescale combating power of the neat cleaning composition 50 g of the neat cleaning composition was placed in a 100 ml beaker. A pre-weighed marble cube was added. It was completely immersed in the cleaning composition. In this test the test periods were 20 minutes, 3 hours and 6 hours. Drying/weighing were as described above.

The results for Example 1 are set out below. As an aid to the interpretation of the figures for Example 1, the following commercial products were tested in the same way.

DOMESTOS OX

HARPIC 100% Limescale Remover (HARPIC LSR)

HARPIC Clear Liquid Bleach (HARPIC CSR)

DOMESTOS Bleach

Diluted:

| | | | Weight |
|---|---|---|---|
| | | | lost (g) |
| | Initial (g) | After 6 h (g) | in 6 h |
| Example 1 | 25.0673 | 23.5559 | 1.5114 |
| DOMESTOS OX | 24.9239 | 24.1159 | 0.808 |
| HARPIC LSR | 24.7797 | 23.8542 | 0.9255 |
| HARPIC CSR | 24.923 | 24.9277 | None |
| DOMESTOS bleach | 24.6959 | 24.6945 | 0.0014 |

Neat:

| | | | | | Weight lost | | |
|---|---|---|---|---|---|---|---|
| | | | | | | 3 | 6 |
| | | | 3 hours | 6 hours | 20 mins | hours | hours |
| | Initial (g) | 20 mins (g) | (g) | (g) | (g) | (g) | (g) |
| Example 1 | 22.8308 | 22.6879 | 21.8477 | 21.23 | 0.1429 | 0.9831 | 1.6008 |
| DOMESTOS | 19.0143 | 18.9864 | 18.6069 | 18.3977 | 0.0279 | 0.4074 | 0.6166 |
| OX | | | | | | | |
| HARPIC | 24.5556 | 24.1326 | 22.4635 | 22.0644 | 0.423 | 2.0921 | 2.4912 |
| LSR | | | | | | | |
| HARPIC | 20.2957 | 20.2983 | 20.2979 | 20.2937 | — | — | 0.002 |
| CSR | | | | | | | |
| DOMESTOS | 19.0184 | 19.0181 | 19.0152 | 19.0145 | 0.0003 | 0.0032 | 0.0039 |
| bleach | | | | | | | |

It will be seen that the limescale removal performance of Example 1 is good to very good.

### EXAMPLE 1

### Bleaching

The Example 1 cleaning composition, admixed just prior to testing, was tested for its bleaching power compared with HARPIC CSR, HARPIC LSR, DOMESTOS bleach and DOMESTOS OX.

1. Preparation of test solution No. 1: sodium metasilicate (2.0 g) was added to deionised water (46.5 ml). After dissolution of the solid, sodium bicarbonate (1.5 g) was added and stirring was continued until all of the solid had dissolved.

2. Preparation of test solution No. 2: Calcium chloride (1.0 g) was dissolved in deionised water (36.0 ml). Magnesium chloride hexahydrate (0.50 g) was then added to the solution. A food grade blue dye (75 mg) and ethanol (12.5 ml) were added and the solution stirred until a uniform solution was obtained.

3. A clean white ceramic tile was placed on a balance and tared. Solution No. 2 (1.8 g) was added dropwise to the tile. Solution No. 1 (2.6 g) was then added to the tile. The solutions were mixed and evenly distributed about the surface of the tile using a toothbrush. The prepared tile was left to dry overnight at ambient temperature.

Testing of bleaching above the water line was as follows.

A few drops of each formulation to be tested (including deionised water for comparison) were placed in a spaced-apart array on the surface of the prepared tile. The tiles were left for 1 hour. The formulations were removed from the tiles using clean tissues (tissues were placed on surface of tile to soak up formulation without washing the dye off the stain, and were carefully removed).

Visual assessment was then made. The Example 1 cleaning composition showed a similar level of bleaching activity to HARPIC CSR and DOMESTOS. It showed better bleaching activity than HARPIC LSR and DOMESTOS OX. The latter two products did not show detectable bleaching in this test. They did show some apparent dissolution of the dye and left prominent “tide marks”.

### EXAMPLE 1

### Biocidal Efficacy

The Example 1 cleaning composition was tested for biocidal efficacy. For reference purposes HARPIC CSR and HARPIC LSR were subjected to the same tests.

The samples were tested using the BS EN1276 suspension test for bactericidal activity, was adapted to provide a more quantitative assessment of efficacy. Samples were tested both neat and diluted to simulate action above and below the water line respectively, in a 2-litre toilet bowl. Activity above the water line was tested after a 2 minute contact time to coincide with the colour change associated with the production of chlorine dioxide. Activity below the water line was tested after a 5 minute contact time. The test was performed against Staphylococcus aureus and Pseudomonas aeruginosa in the presence of organic soil (0.3% bovine albumin in-test).

Neat Samples

Neat samples were evaluated for antimicrobial activity as follows:
1 ml bacterial suspension (10⁸cfu/ml) was transferred to a flask containing 1 ml of a 3% BA suspension (dirty conditions).
The culture/soil mix was vortexed and then shaken in a water bath (20° C.) for 2 minutes.
To the culture/soil mix 4 ml of each of Liquid A and Liquid B of the Example 1 cleaning composition were added simultaneously using a syringe. For the single component liquids (benchmarks), 8 ml was added.
2 minutes after the addition of the sample to the culture/soil mix, a 100 μl aliquot of the test mixture was removed and transferred to 9.9 ml neutralising medium.
After a neutralisation period of 5 minutes, the sample was serially diluted and used to prepare pour plates which were subsequently incubated at 36° C.±1° C. for 48 hours before enumerating surviving bacteria.
The test was performed in duplicate.

Diluted Samples

Diluted samples were prepared in 400 ml of sterile hard water (300ppm CaCO₃ in-test) as follows:
For the Example 1 cleaning composition, 4.8 ml each of liquids A and B were mixed in a sterile pot immediately prior to testing to ensure adequate thickening before addition to the test beaker. Each sample was then added to the beaker by pouring around the rim, to simulate application of the product to the toilet bowl.

The composition was left to pool in the hard water for 5 minutes following application to the beaker rim.

After the 5 minute pooling time, the samples were mixed gently using a magnetic stirrer and immediately evaluated for antimicrobial activity exactly as described above for the neat samples but incorporating the following changes:
8 ml of the diluted product was added to the soil/culture mixture
A contact time of 5 minutes was used rather than 2 minutes
Neutralisation was performed by removing a 1 ml aliquot of the test mixture and transferring it to 9.0 ml neutralising medium
The test was performed in triplicate

Neutralisation validation was performed to ensure that all samples were adequately neutralised during the test.

Results

The Microbiocidal Effect (ME) due to the action of the test sample after 2 minutes (neat) or 5 minutes (diluted), was then calculated using the following equation:—
ME=log N_{c}−log N_{d}
N_{c}=number of cfu/ml added at time 0

N_{d}=number of cfu/ml for the test mixture after the action of the test sample

The results are set out in the table below

| | | ME Value (log cfu/ml) | | | | | | | | | |
|---|---|---|---|---|---|---|---|---|---|---|---|
| | | Staphylococcus | | | | | Pseudomonas | | | | |
| Test Sample | | aureus | | | | | aeruginosa | | | | |
| Example 1 | Neat | | >5.2 | | >5.2 | | | >4.7 | | >4.7 | |
| cleaning | Diluted | >5.1 | | >5.1 | | >5.2 | >4.7 | | >4.7 | | >4.9 |
| composition | | | | | | | | | | | |

The results show that exposure of bacteria to the Example 1 cleaning composition in a standard BS EN1276 suspension test produced considerable reductions in viability.

Reductions in excess of 5.0 log cfu/ml were achieved against Staphylococcus aureus for the neat and diluted Example 1 cleaning composition, in the presence of organic soil and hard water after a 2 minute (neat) or 5 minute (diluted) contact time.

Reductions in excess of 4.5 log cfu/ml were achieved against Pseudomonas. aeruginosa for the neat and diluted Example 1 cleaning composition in the presence of organic soil and hard water after a 2 minute (neat) or 5 minute (diluted) contact time.

In terms of antimicrobial activity, in comparison with commercial products, the Example 1 cleaning composition gave comparable activity in the tests of action when neat, relevant to action above the water line, and was superior in the tests when diluted, relevant to action below the water line.

### Example 2

This is of a dual liquid system to be added to the toilet rim via a two compartment bottle. Equal volumes of each liquid are mixed on delivery.

Liquid A consisted of an unactivated oxidising agent, stabilising agent, anionic surfactant and fragrance.

Liquid B consisted of a dilute mineral acid and blue dyes.

Full compositional information is given below.

LIQUID A

| | | % w/w | % w/w |
|---|---|---|---|
| | Function | Liquid A | Total |
| Ingredient | | | |
| Deionised water | Dilutant | 62.50 | 31.25 |
| Sodium Hydroxide | Stabilising Agent | 10.00 | 5.00 |
| solution 4% w/w, | | | |
| in water | | | |
| Sodium Chlorite 80% w/w, | Oxidising Agent | 0.50 | 0.25 |
| in water | | | |
| Sodium Alkyl | Anionic | 17.00 | 8.50 |
| ethoxy sulphate | Surfactant/Thickener | | |
| 1EO (25% soln, | | | |
| in water) | | | |
| Fragrance pre-mix | Fragrance | 10.00 | |
| | | 100.00 | |
| Fragrance pre-mix | | | |
| Commercial fragrance | Fragrance | 2.00 | 0.100 |
| Sodium Alkyl | Anionic Surfactant | 50.00 | 2.500 |
| ethoxy sulphate | | | |
| 1EO (25% soln, | | | |
| in water) | | | |
| Deionised Water | Dilutant | 48.00 | 2.400 |
| | | 100.00 | 50.000 |

LIQUID B

| | | % w/w | % w/w |
|---|---|---|---|
| | Function | Liquid B | Total |
| Ingredient | | | |
| Hard water | Dilutant | 65.00 | 32.50 |
| Hydrochloric Acid | Acid | 25.00 | 12.50 |
| 37% w/w, in water | | | |
| Dye pre-mix | Dye | 10.00 | |
| | | 100.00 | |
| Dye pre-mix | | | |
| Acid Blue 182 | Readily Oxidised Dye | 0.4000 | 0.020 |
| Methylene Blue | Oxidation Resistant | 0.0250 | 0.001 |
| | Dye | | |
| Hard Water | Dilutant | 99.5750 | 4.979 |
| | | 100.0000 | 50.000 |

The two thin liquids mix to form a dark blue thick liquid. The acid activates the oxidising agent liberating chlorine dioxide. The acid removes limescale. The surfactant causes the substantial thickening, and aids surface action.

A colour change from blue to indigo then to green occurs over approximately 1 minute. On standing overnight the colour becomes pale blue.

### Example 3

This is of a dual liquid system to be added to the toilet rim via a two compartment bottle. Equal volumes of each liquid are mixed on delivery.

Liquid A consisted of an unactivated oxidising agent, stabilising agent and anionic surfactant.

Liquid B consisted of a dilute mineral acid, anionic surfactant, blue dyes and fragrance.

Full compositional information is given below.

LIQUID A

| | | % w/w | % w/w |
|---|---|---|---|
| Ingredient | Function | Liquid A | Total |
| Deionised water | Dilutant | 71.29 | 35.65 |
| Sodium Hydroxide | Stabilising Agent | 10.00 | 5.00 |
| solution 4% w/w, | | | |
| in water | | | |
| Sodium Chlorite 80% w/w, | Oxidising Agent | 0.50 | 0.25 |
| in water | | | |
| Sodium Alkyl | Anionic | 18.21 | 9.11 |
| ethoxy sulphate | Surfactant/Thickener | | |
| 2EO (28% soln, | | | |
| in water) | | | |
| | | 100.00 | |

LIQUID B

| | | % w/w | % w/w |
|---|---|---|---|
| | Function | Liquid B | Total |
| Ingredient | | | |
| Hard water | Dilutant | 65.00 | 32.50 |
| Hydrochloric Acid | Acid | 25.00 | 12.50 |
| 37% w/w, in water | | | |
| Dye and fragrance | Dye and | 10.00 | |
| pre-mix | fragrance | | |
| | | 100.00 | |
| Dye and fragrance | | | |
| pre-mix | | | |
| Acid Blue 182 | Readily Oxidised Dye | 0.4000 | 0.020 |
| Methylene Blue | Oxidation Resistant | 0.0250 | 0.001 |
| | Dye | | |
| Commercial fragrance | Fragrance | 2.00 | 0.100 |
| Sodium alkyl ethoxy | Anionic surfactant | 45.5400 | 2.277 |
| sulphate 2EO (28% | | | |
| soln, in water) | | | |
| Hard Water | Dilutant | 52.0350 | 2.602 |
| | | 100.0000 | 50.000 |

The two thin liquids mix to form a dark blue thick liquid. The acid activates the oxidising agent liberating chlorine dioxide. The acid removes limescale. The surfactant causes the substantial thickening, and aids surface activity.

A colour change from blue to indigo then to green occurs over approximately 1 minute. On standing overnight the colour returned to pale blue.

1. A hard surface cleaner comprising a first precursor composition, being a thin alkaline liquid which contains a compound which generates chlorine dioxide under acidic conditions but not under alkaline conditions, and a second precursor composition, being a thin acidic liquid, wherein on mixing the first and second precursor compositions the resulting admixed cleaning composition is acidic, causing the compound to generate chlorine dioxide, and is more viscous than the first precursor composition and more viscous than the second precursor composition.

2. A cleaning composition cleaner according to claim 1, wherein the viscosity of the first precursor composition is in the range 0.5-100 cps, the viscosity of the second precursor composition is in the range 0.5-100 cps and the viscosity of the cleaning composition produced by admixture thereof is 150-4000 cps.

3. A cleaning composition according to claim 1 wherein the first precursor composition is of pH at least 8, and comprises an alkali metal chlorite stabilised in aqueous solution by an additional base.

4. A cleaning composition according to claim 1, wherein the second precursor composition is of pH not more than 5, and comprises a mineral acid in aqueous solution.

5. A cleaning composition according to claim 1, wherein the pH of the cleaning composition, formed by admixture of the first and second precursor compositions, is not more than 5.5

6. A cleaning composition according to claim 1, wherein the first precursor composition and/or the second precursor composition contains a surfactant which thickens on admixture of the precursor compositions.

7. A cleaning composition according to claim 6, wherein the first precursor comprises such a surfactant, which thickens on admixture with acid.

8. A cleaning composition according to claim 6, wherein the surfactant is an anionic surfactant, being an alkyl sulphate or sulphonate.

9. A cleaning composition according to claim 6, wherein the surfactant is alkoxylated.

10. A cleaning composition according to claim 7, wherein the surfactant is a C₈₋₂₀ alkyl-EO₁₋₄ sulphate, with an alkali metal cation.

11. A cleaning composition according to claim 1, wherein the first and/or second precursor composition comprises a colour change agent which cause a change in appearance on mixing of the precursor compositions.

12. A cleaning composition according to claim 1, being a hard surface cleaner which comprises (% w/w values stated with reference to the total cleaning composition):
0.02-2% w/w, of a compound which under acid conditions generates chlorine dioxide, provided substantially wholly via the first precursor liquid;
0.5-5% w/w, of an alkali metal, alkoxylated C₈₋₂₀ alkyl sulphate surfactant which thickens on being acidified, provided partially or substantially wholly via the first precursor liquid;
20-46% w/w, water, provided via the first precursor liquid;
an alkali metal base, provided substantially wholly via the first precursor liquid, in an amount such as to make the pH thereof at least 12;
20-46% w/w, water, provided via the second precursor liquid;
an acid, provided substantially wholly via the second precursor liquid, in an amount such as to make the pH thereof not more than 5 and the pH of the admixed cleaning composition not more than 0.5 higher than the pH of the second precursor liquid;
wherein the viscosity (as measured herein) of the first precursor liquid is in the range 0.1-100 cps, the viscosity of the second precursor liquid is in the range 0.1-100 cps, and the viscosity of the admixed composition is in the range 150-1400 cps,

13. A hard surface cleaning pack comprising a first chamber containing a first precursor composition, being a thin alkaline liquid which contains a compound which generates chlorine dioxide under acidic conditions but not under alkaline conditions, and a second chamber containing the second precursor composition, being a thin acidic liquid, wherein the chambers are adapted for simultaneous, separate, dispensing of the first and second precursor compositions with downstream mixing thereof, wherein on mixing the first and second precursor compositions the resulting admixed cleaning composition is acidic, causing the compound to generate chlorine dioxide, and is more viscous than both first precursor compositions.

14. A method of cleaning a hard surface, the method comprising use of a cleaning composition according to claim 1 which is an in situ mixture of the first precursor composition and the second precursor composition.

15. A method as claimed in claim 14, comprising the admixture of the first and second precursor compositions, the first precursor composition constituting 30-70 parts by weight of the cleaning composition and the second precursor composition constituting the balance.

16. (canceled)

17. A cleaning composition according to claim 12 being a hard surface cleaner which comprises (% w/w values stated with reference to the total cleaning composition):
0.1-1% w/w, of a compound which under acid conditions generates chlorine dioxide, provided substantially wholly via the first precursor liquid;
1.5-4% w/w, of an alkali metal, alkoxylated C₈₋₂₀ alkyl sulphate surfactant which thickens on being acidified, provided partially or substantially wholly via the first precursor liquid;
28-40% w/w, water, provided via the first precursor liquid;
an alkali metal base, provided substantially wholly via the first precursor liquid, in an amount such as to make the pH thereof at least 12;
28-40% w/w, water, provided via the second precursor liquid;
an acid, provided substantially wholly via the second precursor liquid, in an amount such as to make the pH thereof not more than 5 and the pH of the admixed cleaning composition not more than 0.5 higher than the pH of the second precursor liquid;
wherein the viscosity (as measured herein) of the first precursor liquid is in the range 0.1-100 cps, the viscosity of the second precursor liquid is in the range 0.1-100 cps, and the viscosity of the admixed composition is in the range 150-1400 cps.

18. A cleaning composition according to claim 17
wherein the viscosity (as measured herein) of the first precursor liquid is in the range 1-10 cps, the viscosity of the second precursor liquid is in the range 1-10 cps, and the viscosity of the admixed composition is in the range 150-1400 cps.

19. A cleaning composition according to claim 18
wherein the viscosity of the admixed composition is in the range 500-1000 cps.
